(19) United States
(12) Patent Application Publication
(10) Pub. No.: US 2026/0281311 A1
(43) Pub. Date: Sep. 17, 2026

(54) METHODS AND APPARATUS OF LOCAL ILLUMINATION COMPENSATION MODEL INHERITANCE FOR VIDEO CODING

(71) Applicant: MEDIATEK INC., Hsinchu City (TW)

(72) Inventors: Chih-Hsuan LO, Hsinchu City (TW); Chen-Yen LAI, Hsinchu City (TW); Cheng-Yen CHUANG, Hsinchu City (TW); Ching-Yeh CHEN, Hsinchu City (TW); Yi-Wen CHEN, San Jose, CA (US); Tzu-Der CHUANG, Hsinchu City (TW); Chih-Wei HSU, Hsinchu City (TW)

(21) Appl. No.: 19/472,695

(22) PCT Filed: Sep. 10, 2024
(86) PCT No.: PCT/CN2024/117886

§ 371 Date: Oct. 5, 2025

Related U.S. Application Data
(60) Provisional application No. 63/589,657, filed on Oct. 12, 2023.

(51) Int. Cl. H04N 19/105; H04N 19/159; H04N 19/176

(52) U.S. Cl. CPC H04N 19/105; H04N 19/159; H04N 19/176

(57) ABSTRACT

A method and apparatus for inheriting LIC parameters are disclosed. According to the method, an LIC (Local Illumination Compensation) prediction candidate with inherited LIC parameters inherited from the LIC parameters of the inherited block is derived. The current block is encoded or decoded using a candidate list comprising the LIC candidate, wherein when the LIC candidate is selected for the current block, a predictor for the current block is generated by applying the inherited LIC parameters to a reference block. According to another method, a merge list consisting of LIC parameters of spatial neighbouring blocks, non-adjacent neighbouring blocks, temporal neighbouring blocks, and history-based blocks is generated.

### CROSS REFERENCE TO RELATED APPLICATIONS

The present invention is a non-Provisional application of and claims priority to U.S. Provisional Patent Application No. 63/589,657, filed on Oct. 12, 2023. The U.S. Provisional patent application is hereby incorporated by reference in its entirety.

### FIELD OF THE INVENTION

The present invention relates to video coding system. In particular, the present invention relates to LIC (Local Illumination Compensation) parameter inheritance in a video coding system.

### BACKGROUND AND RELATED ART

Versatile video coding (VVC) is the latest international video coding standard developed by the Joint Video Experts Team (JVET) of the ITU-T Video Coding Experts Group (VCEG) and the ISO/IEC Moving Picture Experts Group (MPEG). The standard has been published as an ISO standard: ISO/IEC 23090-3:2021, Information technology—Coded representation of immersive media—Part 3: Versatile video coding, published February 2021. VVC is developed based on its predecessor HEVC (High Efficiency Video Coding) by adding more coding tools to improve coding efficiency and also to handle various types of video sources including 3-dimensional (3D) video signals.

FIG. 1A illustrates an exemplary adaptive Inter/Intra video encoding system incorporating loop processing. For Intra Prediction 110, the prediction data is derived based on previously coded video data in the current picture. For Inter Prediction 112, Motion Estimation (ME) is performed at the encoder side and Motion Compensation (MC) is performed based on the result of ME to provide prediction data derived from other picture(s) and motion data. Switch 114 selects Intra Prediction 110 or Inter Prediction 112 and the selected prediction data is supplied to Adder 116 to form prediction errors, also called residues. The prediction error is then processed by Transform (T) 118 followed by Quantization (Q) 120. The transformed and quantized residues are then coded by Entropy Encoder 122 to be included in a video bitstream corresponding to the compressed video data. The bitstream associated with the transform coefficients is then packed with side information such as motion and coding modes associated with Intra prediction and Inter prediction, and other information such as parameters associated with loop filters applied to underlying image area. The side information associated with Intra Prediction 110, Inter prediction 112 and in-loop filter 130, is provided to Entropy Encoder 122 as shown in FIG. 1A. When an Inter-prediction mode is used, a reference picture or pictures have to be reconstructed at the encoder end as well. Consequently, the transformed and quantized residues are processed by Inverse Quantization (IQ) 124 and Inverse Transformation (IT) 126 to recover the residues. The residues are then added back to prediction data 136 at Reconstruction (REC) 128 to reconstruct video data. The reconstructed video data may be stored in Reference Picture Buffer 134 and used for prediction of other frames.

As shown in FIG. 1A, incoming video data undergoes a series of processing in the encoding system. The reconstructed video data from REC 128 may be subject to various impairments due to a series of processing. Accordingly, in-loop filter 130 is often applied to the reconstructed video data before the reconstructed video data are stored in the Reference Picture Buffer 134 in order to improve video quality. For example, deblocking filter (DF), Sample Adaptive Offset (SAO) and Adaptive Loop Filter (ALF) may be used. The loop filter information may need to be incorporated in the bitstream so that a decoder can properly recover the required information. Therefore, loop filter information is also provided to Entropy Encoder 122 for incorporation into the bitstream. In FIG. 1A, Loop filter 130 is applied to the reconstructed video before the reconstructed samples are stored in the reference picture buffer 134. The system in FIG. 1A is intended to illustrate an exemplary structure of a typical video encoder. It may correspond to the High Efficiency Video Coding (HEVC) system, VP8, VP9, H.264 or VVC.

The decoder, as shown in FIG. 1B, can use similar or portion of the same functional blocks as the encoder except for Transform 118 and Quantization 120 since the decoder only needs Inverse Quantization 124 and Inverse Transform 126. Instead of Entropy Encoder 122, the decoder uses an Entropy Decoder 140 to decode the video bitstream into quantized transform coefficients and needed coding information (e.g. ILPF information, Intra prediction information and Inter prediction information). The Intra prediction 150 at the decoder side does not need to perform the mode search. Instead, the decoder only needs to generate Intra prediction according to Intra prediction information received from the Entropy Decoder 140. Furthermore, for Inter prediction, the decoder only needs to perform motion compensation (MC 152) according to Inter prediction information received from the Entropy Decoder 140 without the need for motion estimation.

### Partitioning of the CTUs Using a Tree Structure

In High-Efficient Video Coding standard (HEVC), pictures are divided into a sequence of coding tree units (CTUs). A CTU consists of an N×N block of luma samples together with two corresponding blocks of chroma samples for a picture that has three sample arrays, or an N×N block of samples of a monochrome plane in a picture that is coded using three separate colour planes. The CTU concept is broadly analogous to that of the macroblock in previous standards such as Advanced Video Coding (AVC). The maximum allowed size of the luma block in a CTU is specified to be 64×64 in Main profile. A CTU is split into CUs by using a quaternary-tree structure denoted as coding tree to adapt to various local characteristics. The decision whether to code a picture area using inter-picture (temporal) or intra-picture (spatial) prediction is made at the leaf CU level. Each leaf CU can be further split into one, two or four prediction units (PUs) according to the PU splitting type. Inside one PU, the same prediction process is applied and the relevant information is transmitted to the decoder on a PU basis. After obtaining the residual block by applying the prediction process based on the PU splitting type, a leaf CU can be partitioned into transform units (TUs) according to another quaternary-tree structure similar to the coding tree for the CU. One of key feature of the HEVC structure is that it has the multiple partition conceptions including CU, PU, and TU.

Versatile Video Coding standard (VVC) is the successor to HEVC. In VVC, a quadtree with nested multi-type tree using binary and ternary splits segmentation structure replaces the concepts of multiple partition unit types, i.e. it removes the separation of the CU, PU and TU concepts except as needed for CUs that have a size too large for the maximum transform length, and supports more flexibility for CU partition shapes. In the coding tree structure, a CU can have either a square or rectangular shape. A coding tree unit (CTU) is first partitioned by a quaternary tree (a.k.a. quadtree) structure. Then the quaternary tree leaf nodes can be further partitioned by a multi-type tree structure. As shown in FIG. 2, there are four splitting types in multi-type tree structure, vertical binary splitting (SPLIT_BT_VER 210), horizontal binary splitting (SPLIT_BT_HOR 220), vertical ternary splitting (SPLIT_TT_VER 230), and horizontal ternary splitting (SPLIT_TT_HOR 240). The multi-type tree leaf nodes are called coding units (CUs), and unless the CU is too large for the maximum transform length, this segmentation is used for prediction and transform processing without any further partitioning. This means that, in most cases, the CU, PU and TU have the same block size in the quadtree with nested multi-type tree coding block structure. The exception occurs when maximum supported transform length is smaller than the width or height of the colour component of the CU.

FIG. 3 shows a CTU divided into multiple CUs with a quadtree and nested multi-type tree coding block structure, where the bold block edges represent quadtree partitioning and the remaining edges represent multi-type tree partitioning. The quadtree with nested multi-type tree partition provides a content-adaptive coding tree structure comprised of CUs. The size of the CU may be as large as the CTU or as small as 4×4 in units of luma samples. For the case of the 4:2:0 chroma format, the maximum chroma CB size is 64×64 and the minimum size chroma CB consist of 16 chroma samples.

In VVC, the maximum supported luma transform size is 64×64 and the maximum supported chroma transform size is 32×32. When the width or height of the CB is larger the maximum transform width or height, the CB is automatically split in the horizontal and/or vertical direction to meet the transform size restriction in that direction.

In VVC, the coding tree scheme supports the ability for the luma and chroma to have a separate block tree structure. For P and B slices, the luma and chroma CTBs in one CTU have to share the same coding tree structure. However, for I slices, the luma and chroma can have separate block tree structures. When the separate block tree mode is applied, luma CTB is partitioned into CUs by one coding tree structure, and the chroma CTBs are partitioned into chroma CUs by another coding tree structure. This means that a CU in an I slice may consist of a coding block of the luma component or coding blocks of two chroma components, and a CU in a P or B slice always consists of coding blocks of all three colour components unless the video is monochrome.

For each inter-predicted CU, motion parameters consist of motion vectors, reference picture indices and reference picture list usage index, and additional information needed for the new coding feature of VVC to be used for inter-predicted sample generation. The motion parameter can be signalled in an explicit or implicit manner. When a CU is coded with skip mode, the CU is associated with one PU and has no significant residual coefficients, no coded motion vector delta or reference picture index. A merge mode is specified whereby the motion parameters for the current CU are obtained from neighbouring CUs, including spatial and temporal candidates, and additional schedules introduced in VVC. The merge mode can be applied to any inter-predicted CU, not only for skip mode. The alternative to merge mode is the explicit transmission of motion parameters, where motion vector, corresponding reference picture index for each reference picture list and reference picture list usage flag and other needed information are signalled explicitly per each CU.

ITU-T VCEG (Q6/16) and ISO/IEC MPEG (JTC 1/SC 29/WG 5) are studying the potential need for standardization of future video coding technology with a compression capability that significantly exceeds that of the current VVC standard. The Enhanced Compression Model (ECM) reference software is provided to demonstrate a reference implementation of encoding techniques and the decoding process for JVET Enhanced compression beyond VVC capability exploration work. The reference software can be accessed via website, https://vcgit.hhi.fraunhofer.de/ecm/ECM.git. ECM basically is the successor to VVC and thus it shares many common parts as VVC.

In JVET-AF0080 (Luhang Xu, et al., “EE2-2.7: An extrapolation filter-based intra prediction mode”, Joint Video Experts Team (JVET) of ITU-T SG 16 WP 3 and ISO/IEC JTC 1/SC 29, 32nd Meeting, Hannover, DE, 13-20 Oct. 2023, Document: JVET-AF0080), the extrapolation filter-based intra prediction is disclosed. The extrapolation filter-based intra prediction is processed in three steps. First, the min, max and offset values are obtained from a pre-defined reconstructed area. Second, the extrapolation filter coefficients are obtained from the neighbouring reconstructed pixels of the current block's pre-determined template. Third, the extrapolation process generates a predicted value position by position from the top-left to bottom-right corner within the current block.

### Multiple Model CCLM (MMLM)

CCLM included in VVC is extended by adding three Multi-model LM (MMLM) modes (JVET-DO110, Kai Zhang, et al., “Enhanced Cross-component Linear Model Intra-prediction”, Joint Video Exploration Team (JVET) of ITU-T SG 16 WP 3 and ISO/IEC JTC 1/SC 29/WG 11, 4th Meeting: Chengdu, CN, 15-21 Oct. 2016). In each MMLM mode, the reconstructed neighbouring samples are classified into two classes using a threshold which is the average of the luma reconstructed neighbouring samples. The linear model of each class is derived using the Least-Mean-Square (LMS) method. For the CCLM mode, the LMS method is also used to derive the linear model. A slope adjustment to is applied to cross-component linear model (CCLM) and to Multi-model LM prediction. The adjustment is tilting the linear function which maps luma values to chroma values with respect to a centre point determined by the average luma value of the reference samples.

### Slope Adjustment of CCLM

CCLM uses a model with 2 parameters to map luma values to chroma values as shown in FIG. 4A. The slope parameter “a” and the bias parameter “b” define the mapping as follows:

$$chromaVal = a * lumaVal + b$$

An adjustment “u” to the slope parameter is signalled to update the model to the following form, as shown in FIG. 4B:

$$chromaVal = {a}^{′} * lumaVal + {b}^{′} where$$

$${a}^{′} = a + u ,$$

$${b}^{′} = b - u * {y}_{r} .$$

With this selection, the mapping function is tilted or rotated around the point with luminance value yᵣ. The average of the reference luma samples used in the model creation as yᵣ in order to provide a meaningful modification to the model.

### Local Illumination Compensation (LIC)

LIC is an inter prediction technique to model local illumination variation between current block and its prediction block as a function of that between current block template and reference block template. The parameters of the function can be denoted by a scale a and an offset β, which forms a linear equation, i.e., α*p[x]+β to compensate illumination changes, where p[x] is a reference sample pointed to by the MV at a location x in reference picture. When wrap around motion compensation is enabled, the MV shall be clipped with wrap around offset taken into consideration. Since α and β can be derived based on the current block template and the reference block template, no signalling overhead is required for them, except that an LIC flag is signalled for AMVP mode to indicate the use of LIC.

The local illumination compensation proposed in JVET-00066 (Vadim Seregin, et al., “CE4-3.1a and CE4-3.1b: Unidirectional local illumination compensation with affine prediction”, Joint Video Exploration Team (JVET) of ITU-T SG 16 WP 3 and ISO/IEC JTC 1/SC 29/WG 11, 15th Meeting: Gothenburg, SE, 3-12 Jul. 2019, Document: JVET-D0110) is used for uni-prediction inter CUs with the following modifications.
Intra neighbour samples can be used in LIC parameter derivation;
LIC is disabled for blocks with less than 32 luma samples;
For both non-subblock and affine modes, LIC parameter derivation is performed based on the template block samples corresponding to the current CU, instead of partial template block samples corresponding to first top-left 16×16 unit;
Samples of the reference block template are generated by using MC with the block MV without rounding it to integer-pel precision.

### Bi-Predictive LIC

In the method, the LIC mode is extended to bi-predictive CUs. Specifically, two different linear models are applied to the two prediction blocks which are then combined to generate the bi-prediction samples of the current CU, i.e.,

$${P}^{′} [ x , y ] = ( 1 - ω ) \cdot {p}_{0}^{′} [ x , y ] + ω \cdot {p}_{1}^{′} [ x , y ] and$$

$${p}_{0}^{′} [ x , y ] = {α}_{0} \cdot {P}_{0} [ x , y ] + {β}_{0} ,$$

$${p}_{1}^{′} [ x , y ] = {α}_{1} \cdot {P}_{1} [ x , y ] + {β}_{1} ,$$

where α₀ and β₀, and α₁ and β₁ indicate the scales and the offsets in L0 and L1, respectively; w indicates the weight (as indicated by the CU-level BCW index) for the weighted combination of L0 and L1 predictions. The same derivation scheme of the LIC mode is reused and applied in one iterative manner to derive the L0 and L1 LIC parameters. Specifically, the method firstly derives the L0 parameters by minimizing difference between L0 template prediction T₀ and the template T, and the samples in T are updated by subtracting the corresponding samples in T₀. Then, the L1 parameters are calculated that minimizes the difference between L1 template prediction T₁ and the updated template. Finally, the L0 parameter is refined again in the same way.

Following the current LIC design, one flag is signalled for AMVP bi-predicted CUs for the indication of the LIC mode while the flag is inherited for merge related inter CUs. Additionally, the LIC is disabled when decoder-side motion vector refinement (DMVR) (including multi-pass DMVR, adaptive DMVR and affine DMVR) and bi-directional optical flow (BDOF) is applied.

OBMC with LIC

In the method, the OBMC is enabled for the inter blocks that are coded with the LIC mode. In order to reduce the complexity, the OBMC is only applied to the top and left CU boundaries while being always disabled for the boundaries of the internal sub-blocks of one LIC CU. Additionally, when one neighbouring block is coded with the LIC, its LIC parameters are applied to generate the corresponding prediction samples for the OBMC of one current block.

In the present invention, methods and apparatus to inherit LIC parameters from a block that the inherited motion vector comes from are disclosed. In addition, methods and apparatus to generate an LIC candidate list are disclosed.

### BRIEF SUMMARY OF THE INVENTION

A method and apparatus for inheriting LIC parameters are disclosed. According to the method, input data associated with a current block is received, wherein the input data comprises pixel data to be encoded at an encoder side or data associated with the current block to be decoded at a decoder side, wherein the current block inherits an inherited MV (Motion Vector) from an inherited block. An LIC (Local Illumination Compensation) prediction candidate with inherited LIC parameters inherited from the LIC parameters of the inherited block is derived. The current block is encoded or decoded using a candidate list comprising the LIC candidate, wherein when the LIC candidate is selected for the current block, a predictor for the current block is generated by applying the inherited LIC parameters to a reference block.

In one embodiment, the inherited LIC parameters are used to guide derivation of current LIC parameters for the current block. In one embodiment, TM cost is used to determine whether the inherited LIC parameters or derived LIC parameters are used for current block, and wherein the derived LIC parameters are derived using one or more templates of the current block and the reference block. In one embodiment, a CU-level flag is signalled to indicate whether the inherited LIC parameters or the derived LIC parameters are used.

According to another method, input data associated with a current block is received, wherein the input data comprises pixel data to be encoded at an encoder side or data associated with the current block to be decoded at a decoder side, wherein the current block is inter coded. An LIC (Local Illumination Compensation) candidate list is generated, wherein the LIC candidate list comprises first LIC parameters associated with one or more first LIC models for one or more spatial neighbouring blocks, second LIC parameters associated with one or more second LIC models for one or more non-adjacent neighbouring blocks, third LIC parameters associated with one or more third LIC models for one or more temporal neighbouring blocks, fourth LIC parameters associated with one or more fourth LIC models for one or more history-based blocks, or a combination thereof. The current block is encoded or decoded using the LIC candidate list.

In one embodiment, a target LIC candidate is selected from the LIC candidate list for the current block and a predictor for the current block is generated by applying LIC parameters associated with the target LIC candidate to a reference block. In one embodiment, the LIC candidate list further comprises one or more pre-defined LIC parameters.

In one embodiment, an index is signalled to indicate a target LIC candidate selected from the LIC candidate list. In one embodiment, if a reference block is coded by multi-model LIC, multiple LIC models associated with the reference block are inserted into the LIC candidate list.

### BRIEF DESCRIPTION OF THE DRAWINGS

FIG. 1A illustrates an exemplary adaptive Inter/Intra video coding system incorporating loop processing.

FIG. 1B illustrates a corresponding decoder for the encoder in FIG. 1A.

FIG. 2 illustrates examples of a multi-type tree structure corresponding to vertical binary splitting (SPLIT_BT_VER), horizontal binary splitting (SPLIT_BT_HOR), vertical ternary splitting (SPLIT_TT_VER), and horizontal ternary splitting (SPLIT_TT_HOR).

FIG. 3 shows an example of a CTU divided into multiple CUs with a quadtree and nested multi-type tree coding block structure, where the bold block edges represent quadtree partitioning and the remaining edges represent multi-type tree partitioning.

FIG. 4A illustrates an example of the CCLM model.

FIG. 4B illustrates an example of the effect of the slope adjustment parameter “u” for model update.

FIG. 5 illustrates a flowchart of an exemplary video coding system, where the current block inherits an inherited MV from a target block and LIC parameters of the target block are inherited for the current block according to an embodiment of the present invention.

FIG. 6 illustrates a flowchart of an exemplary video coding system, where a merge list consisting of LIC parameters of spatial neighbouring blocks, non-adjacent neighbouring blocks, temporal neighbouring blocks, and history-based blocks according to an embodiment of the present invention.

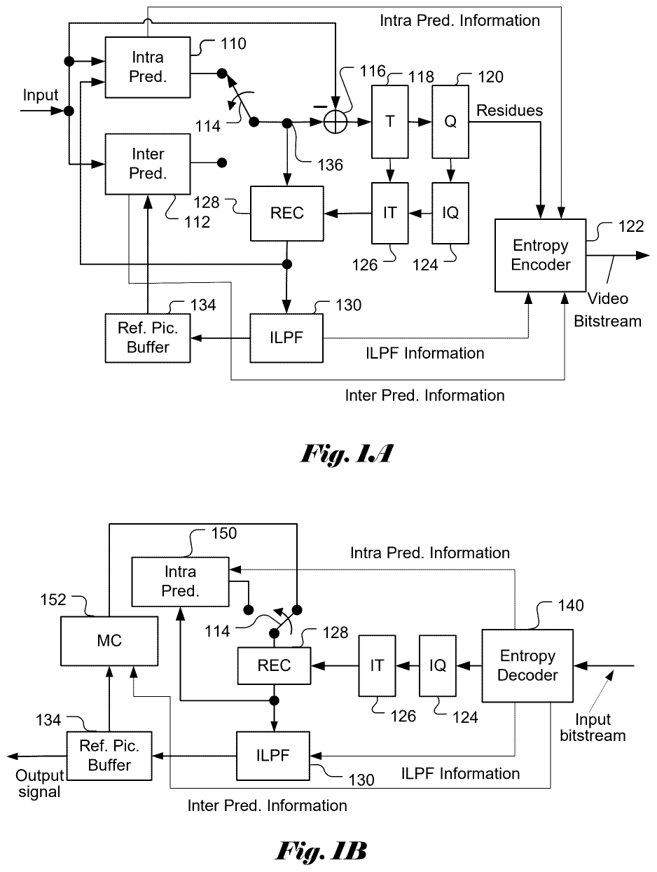

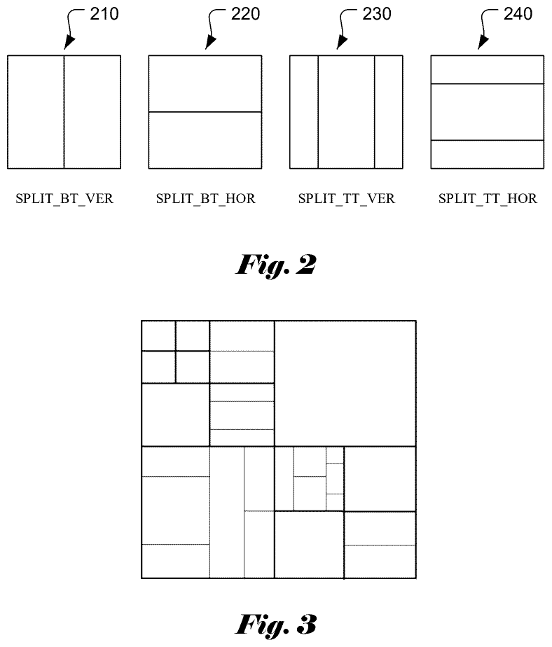

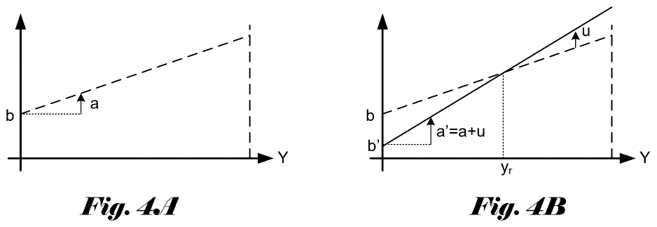

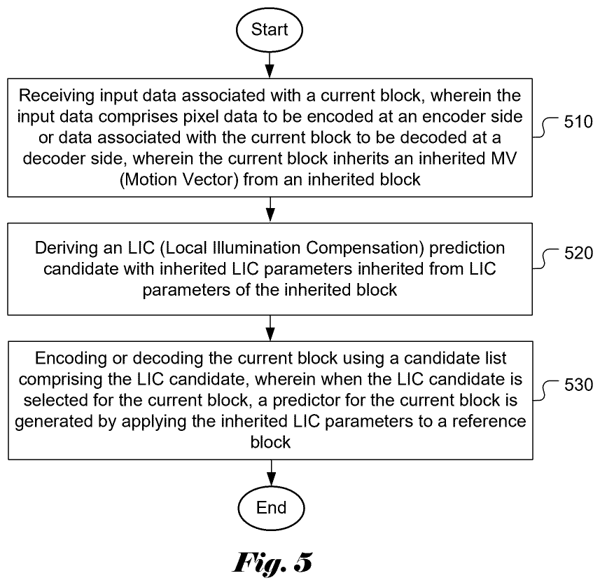

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention. References throughout this specification to “one embodiment,” “an embodiment,” or similar language mean that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention. The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

In order to improve the coding performance of LIC mode, various schemes related to inheriting LIC models are disclosed.

### LIC in Inter Merge Mode

In one embodiment, in inter merge mode, LIC parameters of the reference block pointed by the inherited motion vector can be inherited by the current block. In this case, LIC parameters of the current block do not need to be re-derived again based on the current block's templates and the referenced block's templates.

In another embodiment, in inter merge mode, LIC parameters of the block where inherited motion vector comes from can be inherited by the current block. In this case, LIC parameters of the current block do not need to be re-derived again based on the current block's templates and the referenced block's templates.

In one embodiment, in inter merge mode, LIC parameters of the reference block pointed by the inherited motion vector can be used to guide the derivation of the current block's LIC parameters.

In one embodiment, in inter merge mode, LIC parameters of the block where inherited motion vector comes from can be used to guide the derivation of the current block's LIC parameters.

For example, a regularization term can be added to the derivation process of the current block's LIC parameters. The regularization term is designed based on LIC parameters of the reference block pointed by the inherited motion vector or LIC parameters of the block where inherited motion vector comes from.

For example, a regularization term multiplying with a lambda value can be added to the derivation process of the current block's LIC parameters. The lambda value can be designed based on the current block's prediction mode, current block size, QP value, or motion compensation stage (i.e., final motion compensation, template derivation for list reordering, template derivation for BCW index derivation, template derivation for prediction direction derivation)

In one embodiment, in inter merge mode, a self-derived LIC parameters are derived. The self-derived LIC parameters are derived based on the current block's templates and the reference block's templates. The first cost is calculated based on the current block's templates and the first refined reference block's templates. The first reference block's templates are derived based on self-derived LIC parameters. The second cost is calculated based on the current block's templates and the second refined reference block's templates. The second refined reference block's templates are derived based on LIC parameters of the reference block pointed by the inherited motion vector or LIC parameters of the block where inherited motion vector comes from. After that, the first cost and the second cost multiplying with a ratio are compared.

If the first cost is smaller than the second cost multiplying with a ratio, self-derived LIC parameters will be used to refine the current block. Otherwise, if the second cost multiplying with a ratio is smaller than the first cost, the LIC parameters of the reference block pointed by the inherited motion vector or LIC parameters of the block where inherited motion vector comes from are used to refine current block.

In that, the ratio can be smaller than 1 to favour inherited LIC parameters. Or the ratio can be larger than 1 to favour self-derived LIC parameters. Or the ratio can be equal to 1 for a fair comparison.

In one embodiment, in inter merge mode, a CU-level flag is signalled to indicate self-derived LIC parameters are used or inherited LIC parameters are used.

In one embodiment, in inter merge mode, self-derived LIC parameters are derived. The self-derived LIC parameters are derived based on the current block's templates and the reference block's templates. After that, the self-derived LIC parameters and inherited LIC parameters will be blended with a weighing pair. In this case, the weighting pair can be designed based on the current block's prediction mode, current block size, QP value, or motion compensation stage (i.e., final motion compensation, template derivation for list reordering, template derivation for BCW index derivation, template derivation for prediction direction derivation)

In one embodiment, if the reference block is a bi-prediction coded block, and the current block is a uni-prediction coded block. The corresponding LIC parameters will be referenced by the current block.

For example, if the current block is predicted from a reference picture in list 0. LIC parameters of L0 of the bi-prediction reference block will be referenced by the current picture.

For another example, if the current block is predicted based on a reference picture in list 1, LIC parameters of L1 of the bi-prediction reference block will be referenced by the current picture.

In one embodiment, if the reference block is a bi-prediction coded block, and the current block is a uni-prediction coded block, the corresponding LIC parameters will be referenced by the current block, and the referenced LIC parameters will be further refined. For example, the current block's templates and reference block's templates will be used to refine the inherited LIC parameters.

In one embodiment, if the reference block is a bi-prediction coded block, and the current block is a uni-prediction coded block. The reference block's LIC parameters will not be referenced by current block. Self-derived LIC parameters will be used by the current block.

In one embodiment, if the reference block is a uni-prediction coded block, and current block is a bi-prediction coded block. The reference block's LIC parameters will not be referenced by the current block. Self-derived LIC parameters will be used by the current block.

In one embodiment, if the reference block is a uni-prediction coded block, and the current block is a bi-prediction coded block. The referenced LIC parameters will be used on the corresponding prediction side and the other side's LIC parameters will be further derived by using the current block's templates and the reference block's templates.

In one embodiment, if the reference block is a uni-prediction coded block, and the current block is a bi-prediction coded block. The referenced LIC parameters will be used on the corresponding prediction side (named as the first prediction side), and the second prediction side's LIC parameters will be further derived by using the current block's templates and the reference block's templates. After that, the first prediction side's LIC parameters will be further refined again.

In one embodiment, if the reference block is predicted from L0 and the current block is predicted from L1. The LIC parameters of the reference block can be directly referenced by the current block.

In one embodiment, if the reference block is predicted from L0 and the current block is predicted from L1. The self-derived LIC parameters will be used. The LIC parameters of the reference block will not be used by the current block.

In one embodiment, if the reference block is predicted from L0 and the current block is predicted from L1. The LIC parameters of the reference block can be referenced by the current block, and they will be further refined by using the reference block's templates and the current block's templates.

In one embodiment, the above-mentioned methods are used for motion compensation only.

In one embodiment, the above-mentioned methods are used for list reordering, BCW index refinement, or prediction direction refinement.

In one embodiment, the above-mentioned methods are used for motion compensation only, and for list reordering, BCW index refinement, or prediction direction refinement, LIC are disabled.

In one embodiment, when doing list reordering, BCW index refinement, BVD prediction or prediction direction refinement, LIC are disabled.

### LIC Merge Mode

In one embodiment, an LIC merge list is generated, where the LIC merge list consists of spatial neighbouring block's LIC parameters, non-adjacent neighbouring block's LIC parameters, temporal neighbouring block's LIC parameters, and history-based block's LIC parameters as mentioned in the previous section. In addition, default LIC parameters can also be included in the LIC merge list.

For example, the default LIC parameters are generated by some pre-defined alpha values. After that, the reference templates of the reference block and the current templates of the current block are used to derive the corresponding beta values.

For example, the pre-defined alpha values are closed to 1. For another example, the pre-defined alpha values can be negative or positive.

In one embodiment, if the reference block is coded by multi-model LIC, more than one LIC models will be inserted into LIC merge list.

In one embodiment, if the reference block is coded with slope-adjustment LIC, the adjusted parameters will be inserted into LIC merge list.

In one embodiment, in inter AMVP mode, a CU-level flag is signalled to indicate whether LIC merge mode is used or not. If it is true, an index will be further signalled to indicate which LIC model in LIC merge list is used.

In one embodiment, in inter merge mode, a CU-level flag is signalled to indicate whether LIC merge mode is used or not. If it is true, an index will be further signalled to indicate which LIC model in LIC merge list is used.

In one embodiment, when performing MVP list derivation, LIC is disabled.

In one embodiment, when performing block level reference picture list reordering, LIC is disabled.

In one embodiment, when performing BVD prediction, LIC is disabled.

Any of the foregoing proposed methods of inheriting LIC parameters or generating an LIC candidate list can be implemented in encoders and/or decoders. For example, any of the proposed methods can be implemented in an inter prediction module of an encoder, and/or an inter prediction module of a decoder. Alternatively, any of the proposed methods can be implemented as a circuit coupled to the inter prediction module of the encoder and/or the inter prediction module of the decoder, so as to provide the information needed by the inter prediction module.

FIG. 5 illustrates a flowchart of an exemplary video coding system, where the current block inherits an inherited MV from a target block and LIC parameters of the target block are inherited for the current block according to an embodiment of the present invention. The steps shown in the flowchart may be implemented as program codes executable on one or more processors (e.g., one or more CPUs) at the encoder side. The steps shown in the flowchart may also be implemented based hardware such as one or more electronic devices or processors arranged to perform the steps in the flowchart. According to the method, input data associated with a current block comprising is received in step 510, wherein the input data comprises pixel data to be encoded at an encoder side or data associated with the current block to be decoded at a decoder side, wherein the current block inherits an inherited MV (Motion Vector) from an inherited block. An LIC (Local Illumination Compensation) prediction candidate with inherited LIC parameters inherited from the LIC parameters of the inherited block is derived in step 520. The current block is encoded or decoded using a candidate list comprising the LIC candidate in step 530, wherein when the LIC candidate is selected for the current block, a predictor for the current block is generated by applying the inherited LIC parameters to a reference block.

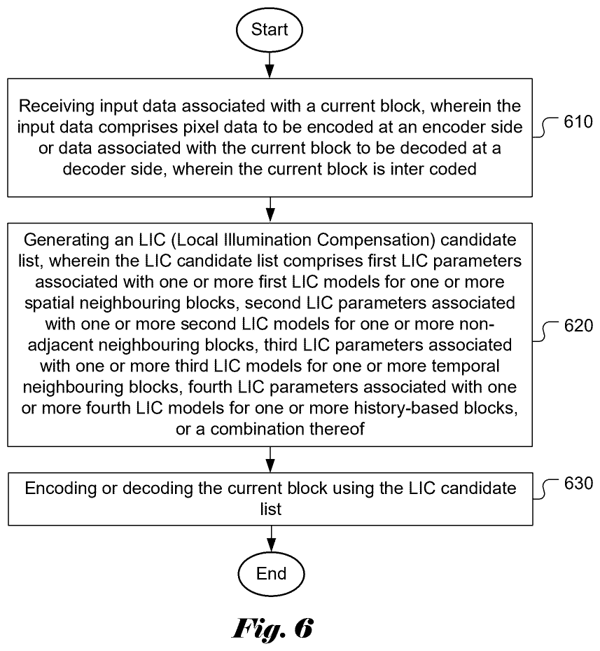

FIG. 6 illustrates a flowchart of an exemplary video coding system, where a merge list consisting of LIC parameters of spatial neighbouring blocks, non-adjacent neighbouring blocks, temporal neighbouring blocks, and history-based blocks according to an embodiment of the present invention. According to another method, input data associated with a current block is received in step 610, wherein the input data comprises pixel data to be encoded at an encoder side or data associated with the current block to be decoded at a decoder side, wherein the current block is inter coded. An LIC (Local Illumination Compensation) candidate list is generated in step 620, wherein the LIC candidate list comprises first LIC parameters associated with one or more first LIC models for one or more spatial neighbouring blocks, second LIC parameters associated with one or more second LIC models for one or more non-adjacent neighbouring blocks, third LIC parameters associated with one or more third LIC models for one or more temporal neighbouring blocks, fourth LIC parameters associated with one or more fourth LIC models for one or more history-based blocks, or a combination thereof. The current block is encoded or decoded using the LIC candidate list in step 630.

The flowcharts shown are intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of video coding, the method comprising:
receiving input data associated with a current block, wherein the input data comprises pixel data to be encoded at an encoder side or data associated with the current block to be decoded at a decoder side, wherein the current block inherits an inherited MV (Motion Vector) from an inherited block;
deriving an LIC (Local Illumination Compensation) prediction candidate with inherited LIC parameters inherited from LIC parameters of the inherited block; and
encoding or decoding the current block using a candidate list comprising the LIC candidate, wherein when the LIC candidate is selected for the current block, a predictor for the current block is generated by applying the inherited LIC parameters to a reference block.

2. The method of claim 1, wherein the inherited LIC parameters are used to guide derivation of current LIC parameters for the current block.

3. The method of claim 1, wherein TM cost is used to determine whether the inherited LIC parameters or derived LIC parameters are used for current block, and wherein the derived LIC parameters are derived using one or more templates of the current block and the reference block.

4. The method of claim 3, wherein a CU-level flag is signalled to indicate whether the inherited LIC parameters or the derived LIC parameters are used.

5. An apparatus for video coding, the apparatus comprising one or more electronics or processors arranged to:
receive input data associated with a current block, wherein the input data comprises pixel data to be encoded at an encoder side or data associated with the current block to be decoded at a decoder side, wherein the current block inherits an inherited MV (Motion Vector) from an inherited block;
derive an LIC (Local Illumination Compensation) prediction candidate with inherited LIC parameters inherited from LIC parameters of the inherited block; and
encode or decode the current block using a candidate list comprising the LIC candidate, wherein when the LIC candidate is selected for the current block, a predictor for the current block is generated by applying the inherited LIC parameters to a reference block.

6. A method of video coding, the method comprising:
receiving input data associated with a current block, wherein the input data comprises pixel data to be encoded at an encoder side or data associated with the current block to be decoded at a decoder side, wherein the current block is inter coded;
generating an LIC (Local Illumination Compensation) candidate list, wherein the LIC candidate list comprises first LIC parameters associated with one or more first LIC models for one or more spatial neighbouring blocks, second LIC parameters associated with one or more second LIC models for one or more non-adjacent neighbouring blocks, third LIC parameters associated with one or more third LIC models for one or more temporal neighbouring blocks, fourth LIC parameters associated with one or more fourth LIC models for one or more history-based blocks, or a combination thereof; and
encoding or decoding the current block using the LIC candidate list.

7. The method of claim 6, wherein a target LIC candidate is selected from the LIC candidate list for the current block and a predictor for the current block is generated by applying LIC parameters associated with the target LIC candidate to a reference block.

8. The method of claim 6, wherein the LIC candidate list further comprises one or more pre-defined LIC parameters.

9. The method of claim 6, wherein an index is signalled to indicate a target LIC candidate selected from the LIC candidate list.

10. The method of claim 6, wherein if a reference block is coded by multi-model LIC, multiple LIC models associated with the reference block are inserted into the LIC candidate list.

11. An apparatus for video coding, the apparatus comprising one or more electronics or processors arranged to:
receive input data associated with a current block, wherein the input data comprises pixel data to be encoded at an encoder side or data associated with the current block to be decoded at a decoder side, wherein the current block is inter coded;
generate an LIC (Local Illumination Compensation) candidate list, wherein the LIC candidate list comprises first LIC parameters associated with one or more first LIC models for one or more spatial neighbouring blocks, second LIC parameters associated with one or more second LIC models for one or more non-adjacent neighbouring blocks, third LIC parameters associated with one or more third LIC models for one or more temporal neighbouring blocks, fourth LIC parameters associated with one or more fourth LIC models for one or more history-based blocks, or a combination thereof; and
encode or decode the current block using the LIC candidate list.
